(19) United States
(12) Patent Application Publication
(10) Pub. No.: US 2004/0136697 A1
(43) Pub. Date: Jul. 15, 2004

(54) Apparatus and method for recording multimedia data with high efficiency

(76) Inventor: Dong-Hyun Chang, Suwon-city (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/743,378

(22) Filed: Dec. 23, 2003

(30) Foreign Application Priority Data
Dec. 27, 2002 (KR) 2002-85381

(51) Int. Cl. H04N 5/76

(52) U.S. Cl. 386/111; 386/112

(57) ABSTRACT

An apparatus and method for recording multimedia data is disclosed. The apparatus and method employ a receiving unit for receiving compressed multimedia signal, a decoder unit for decoding the multimedia signal to convert it into a data stream having a predetermined format, a data compression unit for reducing the amount of data in the data stream by a certain amount and encoding it, a compression select unit for setting a compressibility of the data compression unit, and a storage unit for storing the encoded data. In accordance with the apparatus for recording the multimedia data, in the case where there is no need to record the video data with high quality, it is possible to increase the recording time of the multimedia data by reducing the data amount of the video signal using a variety of compression methods when the multimedia data is recorded in a storage device.

### PRIORITY

The present invention claims priority under 35 U.S.C. §119 from Korean Patent Application No. 2002-85381 filed Dec. 27, 2002 entitled “Apparatus for Recording Multimedia Data with High Efficiency,” the contents of which are incorporated herein by reference in their entirety.

### BACKGROUND

1. Field of the Invention

The present invention generally relates to an apparatus and method for recording multimedia data such as a digital audio signal and a digital video signal, and more particularly, to an apparatus and method for recording multimedia data with greater efficiency such that the recording time of the multimedia data is increased.

2. Brief Description of the Related Art

Digital multimedia data, and in particular digital audio and video signals, are considerably larger in terms of file space occupancy, and so on, as compared to analog multimedia data. In a case where digital multimedia data is stored on storage devices such as a memory or a hard disk drive (HDD), the recording time of the storage devices is slower than for analog multimedia data.

FIG. 1 is a block diagram of a conventional set top box capable of recording digital multimedia data. The set top box shown comprises a tuner 10, a demodulator 20, a demultiplexer 30, a hard disk drive (HDD) 40, MPEG decoder 50, and a video encoder 60. The tuner 10 receives broadcasting signals being sent via a broadcast station or cable networks, and selects one of the received broadcasting signals.

The demodulator 20 removes the carrier wave from the broadcasting signal selected by the tuner 10. The broadcasting signals having the carrier wave removed by the demodulator comprises a digital data stream which the broadcast station intended to transmit. In general, the digital data stream is encoded in MPEG-2 format. Accordingly, the digital data stream is compressed based on the MPEG-2 standard.

Demultiplexer 30 separates the digital data stream into a video signal and an audio signal. The hard disk drive (HDD) 40 stores the video signal and the audio signal which were separated by the demultiplexer 30. At this time, the video signal and the audio signal stored on the hard disk drive (HDD) 40 are compressed according to MPEG-2 standard.

MPEG decoder 50 and the video encoder 60 reproduce the video signal and audio signal stored on the hard disk drive (HDD). MPEG decoder 50 decompresses the compressed video signal and audio signal according to a standard such as the MPEG-2 standard, and the video encoder 60 converts the decompressed signals into the video format of image display devices such as a television. The video format is typically either NTSC or PAL, although those of ordinary skill in the art will appreciate that any suitable video format of a display device is acceptable and is considered to be within the spirit of the present invention.

On the other hand, in a set top box having the configuration described above, in a case where a user desires to record broadcasting programs that are supplied via the tuner 10 having a long duration, it is required to increase the capacity of the hard disk drive (HDD) or to erase the previous data stored on the hard disk drive (HDD) 40. One way to increase the capacity of the hard disk drive (HDD) 40, is to add an additional hard disk drive (HDD). However, this disadvantageously increases the cost of manufacturing the set top box.

There is no need to store the video signal on the hard disk drive (HDD) 40 with high quality if the programs are news programs or musical programs of which the principal object is for listening. Nevertheless, conventionally the capacity of the hard disk drive (HDD) is unnecessarily consumed by storing the video signal based on the MPEG-2 standard on the hard disk drive (HDD) 40 for all programs.

### SUMMARY

The above described problems are substantially overcome and other advantages are realized by embodiments of the present invention. It is one aspect of the present invention to provide an apparatus for recording multimedia data with the recording time of the multimedia data being increased.

In order to accomplish the above aspects and to realize other advantages of the present invention, a recording apparatus according to an embodiment of the present invention comprises a receiving unit for receiving a compressed multimedia signal, a decoder unit for decoding the multimedia signal to convert it to data stream having a predetermined format, a data compression unit for reducing and encoding the amount of the data stream by a certain amount, a compression select unit for setting the compressibility of the data compression unit, and a data storage unit for storing the encoded data.

The decoder unit preferably comprises a demodulator for removing the carrier wave from the received broadcast multimedia signal, a demultiplexer for decoding the multimedia signal having the carrier wave removed and separating it into video signal and audio signal, and a decoder for decompressing the compressed video signal and the audio signal.

Preferably, the decoder unit further comprises a format setting unit for setting the format of the video and audio signals outputted from the demultplexer to be one of PES (Packetised Elementary Stream) in a packet unit and TS (Transport Stream) in a pack unit.

The data compression unit preferably comprises a data conversion unit for reducing a portion of data making up the decompressed video and audio signals according to the compressibility set by the compression select unit, and an encoder for recompressing the video data and audio data having a predetermined portion of data reduced by the data conversion unit.

The data conversion unit preferably comprises a memory for storing the decompressed data from the decoder in a frame unit; a frame setting unit, enabled by the compression select unit, for removing frames of the data stored on the memory (such as even-numbered frames), and to re-store it on the memory; and an encoder for compressing the data stream re-stored on the memory.

Preferably, the data conversion unit further comprises a format conversion unit, enabled by the compression select unit, for converting the signal format of the video signal stored on the memory into 4:2:0 format to re-store on the memory.

Preferably, the data conversion unit further comprises a scaler that is enabled by the compression select unit and reduces the resolution of the video signal stored in frame unit on the memory to a certain resolution before re-storing the video signal having the reduced resolution in the memory.

The compression select unit preferably generates a first control signal that causes the video signal and the audio signal to be outputted to any one of the decoder and the storage unit by controlling the demultiplexer, and a second control signal that causes at least one of the frame setting unit, the format conversion unit, and the scaler to be enabled by controlling the data conversion unit.

Preferably, the format described above is any one of MPEG-1, MPEG-2, MPEG-3, and MPEG-4. Also, the receiving unit receives a multimedia signal having any one of MPEG-1, MPEG-2, MPEG-3, and MPEG-4 formats.

### BRIEF DESCRIPTION OF THE DRAWINGS

The present invention will be described in connection with a particular embodiment thereof, and will be better understood with reference to the accompanying drawing figures, in which:

FIG. 1 is a block diagram of a conventional set top box capable of recording digital multimedia data;

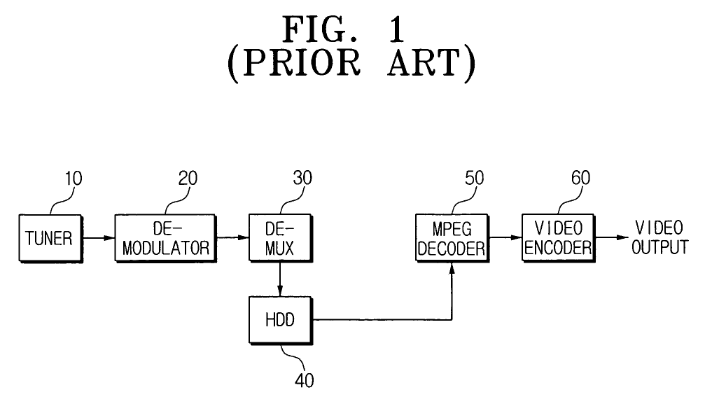

FIG. 2 is a block diagram of a set top box having a device for storing multimedia data according to an embodiment of the present invention; and

FIG. 3 is a detailed block diagram of a data compression unit according to an embodiment of the present invention.

It should be understood that in the drawing figures, like reference numbers refer to like features and structures.

### DETAILED DESCRIPTION OF THE PREFERRED EMBODIMENT

The above mentioned objects, as well as other objects, features and advantages of an embodiment of the present invention will be better understood from the following description taken in conjunction with the attached drawing figures.

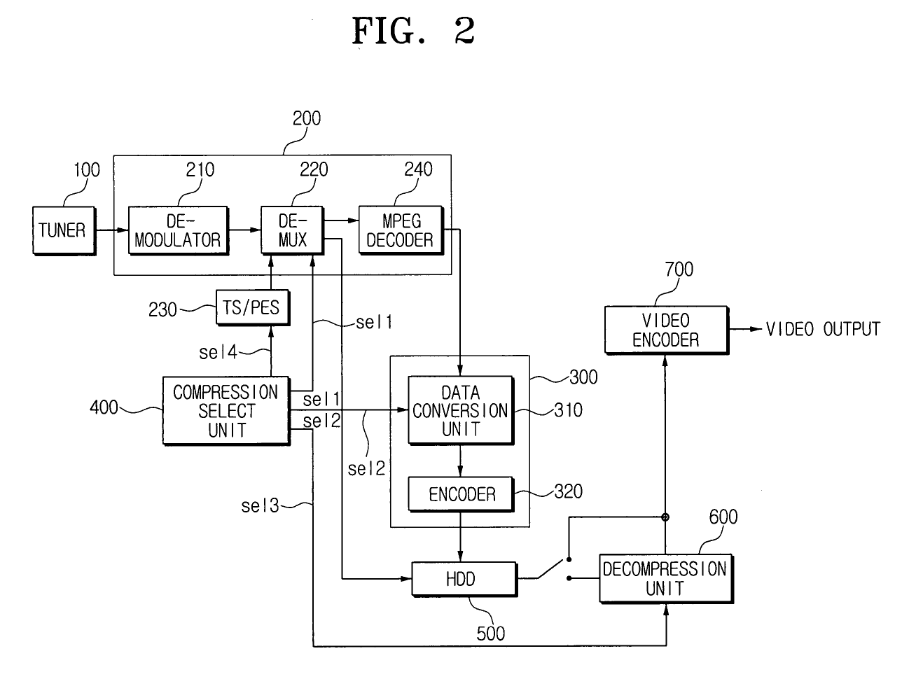

FIG. 2 is a block diagram of an example of a set top box having a device for storing multimedia data according to an embodiment of the present invention. The set top box shown comprises a tuner 100, a decoder unit 200, a data compression unit 300, a compression select unit 400, a hard disk drive (HDD) 500, a decompression unit 600, and a video encoder 700.

The tuner 100 selects one of a plurality of broadcasting signals supplied via broadcast stations or cable networks according to a predetermined channel. At this time, the received broadcasting signal is typically encoded in any one of the MPEG-1-MPEG-4 standards, and it will be described on the basis of MPEG-2 format in this embodiment. Thus, the broadcasting signal selected by the tuner 100 is the video signal and audio signal based on MPEG-2 format that is modulated with a carrier wave having a predetermined frequency.

The decoder unit 200 removes the carrier wave from the broadcasting signal selected by the tuner 100 and decodes it, thereby converting the signal to a data stream having a predetermined format (MPEG-2 in the described example).

The data compression unit 300 is controlled by the compression select unit 400, and receives the data stream outputted from the decoder unit 200 and reduces the data size of the data stream according to at least one method. In order to reduce the data size of the data stream, this embodiment uses any one of three methods. The first is a method for converting a video signal having typically a 4:4:2 format to a 4:2:0 format. The second is a method for removing even-numbered frames of the video signalThe third is a method for reducing the resolution of the video signal. These methods will be described in further detail below.

The compression select unit 400 generates, in response to a control signal generated from a setting key (not shown) or a remote controller (not shown) included in the present set top box, a control signal (sel1) for setting the output direction of the data stream outputted from the demultiplexer 220. Based on the control signal (sel1), the output of demultiplexer 220 can be provided to decoder 240 or to hard disk drive 500. Compression select unit 400 also generates a control signal (sel2) for setting the compression method of the supplied data stream in the data compression unit 300. Also, compression select unit 400 generates a control signal (sel3) for enabling/disabling the decompression unit 600. Furthermore, compression select unit 400 generates a control signal (sel4) for setting the format of the data stream outputted from the decoder unit 200. Here, the control signal (sel2) is composed of 2 bits for setting three compression methods. The selected compression method may use only one of the above-described methods, or may use a combination of the above-described methods. For example, it is possible to convert the format of the video signal to 4:2:0 format while also reducing the resolution of the data stream having MPEG format outputted from the decoder unit 200.

The hard disk drive (HDD) 500 stores the video signal and the audio signal in MPEG format compressed by the data compression unit 300 according to the method selected by the compression select unit 400. The amount of data stored on the hard disk drive (HDD) 500 depends on the combination of the methods selected by the compression select unit 400, and it is possible to store the video signal and the audio signal reduced to 1/16 according to the selection of the compression method on the video signal and the audio signal. In other words, the capacity of data storage can be dramatically increased with a device according to an embodiment of the present invention.

The decompression unit 600 performs MPEG decoding on the video signal and the audio signal stored in the hard disk drive (HDD) 500. In a video encoder 700, the decoded video signal and audio signal are converted into the video format of NTSC/PAL according to the control signal (sel4) from the compression unit 400.

Preferably, the decoder unit 200 includes a demodulator 210, a demultiplexer 220, a format setting unit 230, and a decoder 240.

The demodulator 210 removes the carrier wave from the broadcasting signal selected by the tuner 100. The broadcasting signal having the carrier wave removed by the demodulator 210 comprises the digital data stream which the broadcast station intended to transmit. In this embodiment, the digital data stream has MPEG-2 format, and is compressed based on MPEG-2 standard.

The demultiplexer 220 separates the digital data stream into a video signal and an audio signal, and the hard disk drive (HDD) 500 stores the video signal and the audio signal separated by the demultiplexer 220. At this time, the video signal and the audio signal held in the hard disk drive (HDD) 500 are compressed according to MPEG-2 standard. Additionally, the demultiplexer 220 directly sends the video signal and the audio signal to the hard disk drive (HDD) 500 when the control signal (sel1) from the compression select unit 400 is enabled. Consequently, in the case of a video signal requiring high quality, it is possible to store the video signal in the hard disk drive (HDD) without carrying out a separate compression process.

The format setting unit 230 sets, in response to the control signal (sel4) from the compression select unit 400, the data stream having MPEG-2 format outputted from the demultiplexer 230 to be any one of PES format in a packet unit and TS format in a pack unit. The format setting unit 230 preferably sets the output of the demultiplexer 220 to be TS format when the control signal (sel4) is enabled, and the output of the demultiplexer 220 to be PES format when the control signal (sel4) is disabled. Here, if the data stream is PES unit, the data stream from the demultiplexer 230 is supplied to the decoder 240 as it is, and has a signal format capable of being stored in a scrambled format on the hard disk drive (HDD). If the data stream is TS unit, the output of the demultiplexer 220 may be stored on the hard disk drive (HDD) 500 in unscrambled format. The scrambling term used herein refers to the broadcast station or the enterpriser of the cable networks encoding the broadcasting signal so that only viewers authorized to view the broadcasting signal are able to watch the broadcasting signal. The format setting unit 230 causes the broadcasting signal to be stored under encoding or to be decoded before being stored. The decoder 240 performs MPEG decoding on the video signal and the audio signal.

Preferably, the data compression unit 300 comprises a data conversion unit 310 and an encoder 320. The data conversion unit 310 is controlled by the compression select unit 400, and reduces the amount of data in the decompressed video signal and audio signal from the decoder 240 depending on one of the three methods discussed above. The first method converts a video signal having 4:4:2 format to a video signal having 4:2:0 format. The second method removes even-numbered frames of the moving video signal. The third method reduces the resolution of the video signal. The encoder 320 compresses the data stream having the data amount removed according to MPEG-2 format.

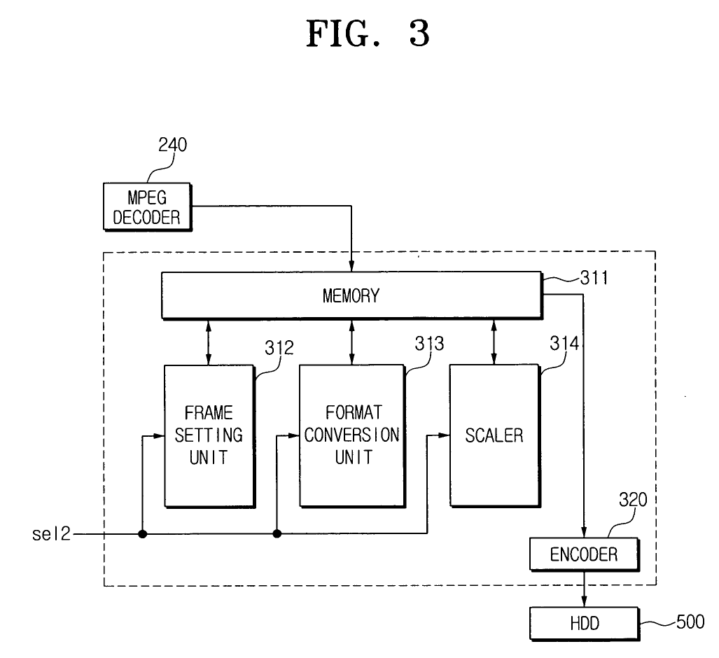

FIG. 3 is a detailed block diagram of an example of the data compression unit 300. The data compression unit 300 comprises a memory 311, a frame setting unit 312, a format conversion unit 313, and a scaler 314.

The memory 311 receives the video signal and the audio signal decompressed by the decoder 240 and stores it in a frame unit. The frame setting unit 312 is enabled/disabled by the control signal (sel2) supplied from the compression select unit 400, and when enabled, receives the video signal stored in the memory 311 before removing even-numbered frames of the video signal and then resending the remaining frames to the memory. Thereby, the video signal having the even-numbered frames removed is stored in the memory 311.

The format conversion unit 313 is enabled/disabled by the control signal (sel2), and when enabled, converts the format of the video signal held in the memory 311 to 4:2:0 format. The 4:2:0 format is the ratio of the sampling frequencies of the luminance signal to the color difference signals, and is a method representing the video signal based on International Telecommunication Union-Radio Communication Sector (ITU-R) recommendation 601 standard. This format reduces the data amount of the video signal by using the characteristic that the human eye is sensitive to the luminance signal, whereas it is less sensitive to color difference signals. The format of a video signal not having the color difference signal (Cb, Cr) removed is referred to as 4:4:4 format. The format of a video signal having the color difference signals (Cb, Cr) reduced to ½ for compressing the video signal is referred to as 4:2:2 format. The format of a video signal having the color difference signals (Cb, Cr) reduced to ¼ is referred to as 4:2:0 format. MPEG-2 format generally transmits/receives the video signal by means of 4:2:2 video format, and the format conversion unit converts the video signal having 4:2:2 video format into a video signal having 4:2:0 video format, thereby reducing the data amount of the video signal by half.

The scaler 314 is enabled/disabled by the control signal sel2, and when enabled, reduces the resolution of the video signal held in the memory 311. For example, if the resolution of the video signal inputted is 800×600, the scaler 311 reduces it to 640×480 or less. The video signal having the resolution reduced is re-stored in the memory 311. Thereby, the video signal held in the memory 311 is reduced in the data amount as compared with the video signal supplied to the tuner 100, and hence when the reduced data is stored in the hard disk drive (HDD) 500, the available recording time of the multimedia data becomes longer.

Although a particular exemplary embodiment of the present invention has been disclosed with reference to the appended drawing figures and the preferred embodiments of the present invention corresponding to the drawing figures has been described, it should be understood that the descriptions in the present specification are only for illustrative purpose, and not for limiting the scope of the present invention.

Also, those who are skilled in the art will appreciate that various modifications, additions and substitutions are possible without departing from the scope and spirit of the present invention. Therefore, it should be understood that the present invention is limited only to the accompanying claims and the equivalents thereof, and includes the aforementioned modifications, additions and substitutions.

What is claimed is:

1. An apparatus for recording multimedia data comprising:
a receiving unit for receiving a compressed multimedia signal;
a decoder unit for decoding the multimedia signal into a data stream having a predetermined format;
a data compression unit for reducing a data amount of the data stream by a certain amount and encoding the reduced data stream;
a compression select unit for setting a compressibility of the data compression unit; and
a storage unit for storing the encoded data.

2. The apparatus of claim 1, wherein the decoder unit comprises:
a demodulator for removing a carrier wave from the multimedia signal;
a demultiplexer for decoding the multimedia signal into a video signal and an audio signal after the carrier wave is removed from the multimedia signal; and
a decoder for decompressing the video signal and the audio signal.

3. The apparatus of claim 2, further comprising a format setting unit for setting the format of the video signal and the audio signal from the demultiplexer to one of PES in a packet unit and TS in a pack unit.

4. The apparatus of claim 1, wherein the data compression unit comprises:
a data conversion unit for reducing a portion of the data of the decompressed video signal and the audio signal according to the compressibility set by the compression select unit; and
an encoder unit for recompressing the video data and the audio data after the portion of the data is reduced by the data conversion unit.

5. The apparatus of claim 4, wherein the data conversion unit comprises:
a memory for storing the decompressed data from the decoder in a frame unit;
a frame setting unit, enabled by the compression select unit, for removing frames of the data stored on the memory and re-storing the data in the memory; and
an encoder for compressing the data stream re-stored in the memory.

6. The apparatus of claim 5, wherein the frame setting unit removes even-numbered frames.

7. The apparatus of claim 5, further comprising a format conversion unit, enabled by the compression select unit, for converting the signal format of the video signal held in the memory to 4:2:0 format and re-storing the data in the memory.

8. The apparatus of claim 7, further comprising a scaler, enabled by the compression select unit, for reducing the resolution of the video signal stored in a frame unit on the memory to a certain resolution and re-storing the data in the memory.

9. The apparatus of claim 1, wherein the compression select unit generates a first control signal that causes the video signal and the audio signal to be outputted to any one of the decoder and the storage unit by controlling the demultiplexer, and a second control signal that causes at least one of the frame setting unit, the format conversion unit and the scaler to be enabled by controlling the data conversion unit.

10. The apparatus of claim 1, wherein the predetermined format is selected from the group consisting of MPEG-1, MPEG-2, MPEG-3, and MPEG-4.

11. The apparatus of claim 1, wherein the receiving unit receives a multimedia signal compressed with any one of the compression formats selected from the group consisting of MPEG-1, MPEG-2, MPEG-3, and MPEG-4.

12. A method for recording multimedia data comprising:
receiving a compressed multimedia signal;
decoding the multimedia signal into a data stream having a predetermined format;
reducing a data amount of the data stream by a certain amount and encoding the reduced data stream;
setting a compressibility of the data as reduced in the reducing step; and
storing the encoded data.

13. The method of claim 12, further comprising the steps of:
removing a carrier wave from the multimedia signal;
decoding the multimedia signal into a video signal and an audio signal after the carrier wave is removed from the multimedia signal; and
decompressing the video signal and the audio signal.

14. The method of claim 12, further comprising the steps of:
setting the format of the video signal and the audio signal to one of PES in a packet unit and TS in a pack unit.

15. The method of claim 12, further comprising the steps of:
reducing a portion of the data of the decompressed video signal and the audio signal according to the compressibility set; and
recompressing the video data and the audio data after the portion of the data is reduced by the data conversion unit.

16. The method of claim 15, further comprising the step of:
storing the decompressed data in a memory;
removing frames of the data;
re-storing the data; and
compressing the re-stored data stream.

17. The method of claim 16, wherein even-numbered frames are removed during the removing step.

18. The method of claim 16, further comprising the step of converting the signal format of the video signal to 4:2:0 format and re-storing the data.

19. The method of claim 18, further comprising the step of reducing the resolution of the video signal to a certain resolution and re-storing the data.

20. The method of claim 12, further comprising the steps of:
generating a first control signal that causes the video signal and the audio signal to be outputted to any one of a decoder and a storage unit by controlling a demultiplexer, and a second control signal that causes at least one of the steps selected from the group consisting of removing frames, converting the signal format, and reducing the resolution of the video signal, to be performed.

21. The apparatus of claim 12, wherein the predetermined format is selected from the group consisting of MPEG-1, MPEG-2, MPEG-3, and MPEG-4.

22. The apparatus of claim 12, wherein the receiving step further comprises receiving a multimedia signal compressed with any one of the compression formats selected from the group consisting of MPEG-1, MPEG-2, MPEG-3, and MPEG-4.
